(19) United States
(12) Patent Application Publication
(10) Pub. No.: US 2012/0260567 A1
(43) Pub. Date: Oct. 18, 2012

(54) MODULAR PLANTER SYSTEM

(76) Inventor: Steven Tupu, New York, NY (US)

(21) Appl. No.: 13/087,249

(22) Filed: Apr. 14, 2011

(51) Int. Cl. A01G 1/00; B23P 11/00

(52) U.S. Cl. 47/33; 29/428

(57) ABSTRACT

Systems, methods and devices are provided that include one or more modular planter curbs, wherein each modular planter curb includes a concrete unit that has a back side that is substantially upright, that has a front side that tapers from a wider lower portion to a narrower upper portion, and that has a height not exceeding 24 inches. The concrete unit may include precast concrete, cast stone, and/or precast stone. Each modular planter curb also may include connector points, and connector hardware may be used to interconnect the plurality of modular planter curbs at the connector points. In some embodiments, a modular planter curb may be selected from the group comprising a bench curb, a backrest curb, a daybed curb, a transition curb, a straight curb, a curved curb, an annular arc curb, and a full annular curb. Numerous other aspects are provided.

### BACKGROUND OF THE INVENTION

1. Field of the Invention

This invention relates to modular structures for use in landscape architecture and design, and in particular, to a modular planter system suitable as a retaining enclosure for soil and vegetation in rooftop landscaping.

2. Description of Related Art

Historically, inner-city buildings often have limited landscaping because of expansive concrete foundations and sidewalks. Recognizing the importance of foliage to the environment, many urban planners have sought to plant trees and shrubs in places where few previously have been. Within the field of landscape architecture, a “green roof” has become a popular outlet for urban landscapes, especially where ground-level planting is restricted by sidewalks and other fixed surfaces.

A green roof connotes a flat roof having a number of planters containing assorted vegetation, such as shrubs, groundcovers, vegetables, perennials, grasses and/or small trees. In some cases, the green roof may include a foot path, benches, a water fountain and/or water fall. Sometimes a green roof may be enclosed to form a greenhouse or atrium. An exemplary green roof may be designed to resemble a mini-forest. Scale, location, vegetation, budget, and motif are just a few of the variables that go into an overall design of a green roof. Conversely, the design of the green roof often plays a factor in the assortment, arrangement, number and concealment of the planters holding the vegetation. For instance, planters may be concealed to avoid reminding an observer that the person is on a roof in the city, and to achieve a more-naturally-looking design.

Conventionally, a green roof may include planters of different shapes and sizes, such as pots and troughs, and each planter needs to manage several competing factors, including water collection & drainage, soil retention & erosion, and stabilization & weight reduction. Plants need some water, but not too much water, so planters need controlled drainage. Drainage from planters, however, can create standing water on a roof, which also is undesirable. Likewise, plants need soil, but drainage can erode the soil from a planter to a roof, with the unwanted results of dirt on the roof and possibly clogged gutters. Furthermore, planters need to be stable to resist the influences of people and wind on the vegetation that might cause the planters to tip and/or topple, and stability may be achieved by a planter's low-lying weight, but too much weight may damage the roof.

Attachment and stabilization of a planter to a roof is an important consideration. One conventional approach includes using a metal edge that is attached to a concrete slab and therefore penetrates the roof's waterproofing membrane. Another conventional approach includes using a heavy masonry structure that is complex and attaches into an existing concrete slab. Both of these conventional methods are costly, are complicated, and put roof waterproofing integrity at risk. Consequently, retrofitting a roof not initially designed to have a garden can be a challenging task, because the roof may not be well-suited to handle the negative effects of the water, soil and added weight that accompany conventional planters.

In light of the disadvantages of conventional planters, a new type of retaining structure is desirable that allows for more efficient and/or effective use of available space, for more strength for less weight, for more effective drainage, and for less detrimental impact on the surface supporting the retaining structure.

### BRIEF SUMMARY OF THE INVENTION

In a first aspect of the invention, a modular planter curb is provided. The modular planter curb includes a concrete unit that has a back side that is substantially upright, that has a front side that tapers from a wider lower portion to a narrower upper portion, and that has a height not exceeding 24 inches. The concrete unit may comprise precast concrete, cast stone, and/or precast stone.

In a second aspect of the invention, a system is provided that includes a plurality of modular planter curbs, wherein each modular planter curb includes a concrete unit that has a back side that is substantially upright, that has a front side that tapers from a wider lower portion to a narrower upper portion, and that has a height not exceeding 24 inches. The concrete unit may comprise precast concrete, cast stone, and/or precast stone. Each modular planter curb also includes connector points, and the system includes connector hardware to interconnect the plurality of modular planter curbs at the connector points. In some embodiments, the connector hardware interconnects the plurality of modular planter curbs at the connector points.

In exemplary embodiments of the first or second aspect, the modular planter curb may include a bench curb, and the concrete unit may include a bench top above the narrower upper portion. The modular planter curb also may include a backrest secured to the concrete unit, forming a backrest curb. Alternatively, the modular planter curb may include a daybed secured to the concrete unit, forming a daybed curb. In some cases, the modular planter curb may comprise a transition curb, and the concrete unit may comprise a bench top, a simple upper portion, and a transition from the bench top to the simple upper portion. Various embodiments may include a straight curb, a curved curb, an annular arc curb, or a full annular curb.

In a third aspect of the invention, a method is provided for forming a configuration of a modular planter system, and the method includes forming a first modular planter curb, wherein the first modular planter curb comprises a first concrete unit that has a first back side that is substantially upright, that has a first front side that tapers from a first wider lower portion to a first narrower upper portion, and that has a first height not exceeding 24 inches. The first concrete unit may comprise precast concrete, cast stone, and/or precast stone.

In exemplary embodiments of the third aspect, the method also may include forming a second modular planter curb, wherein the second modular planter curb comprises a second concrete unit having a second back side that is substantially upright, having a second front side that tapers from a second wider lower portion to a second narrower upper portion, and having a second height not exceeding 24 inches. The second concrete unit may comprise precast concrete, cast stone, and/or precast stone. The first modular planter curb and the second modular planter curb may differ and be selected from the group comprising a bench curb, a backrest curb, a daybed curb, a transition curb, a straight curb, a curved curb, an annular arc curb, and a full annular curb.

The method may further include forming at least one first connector point on the first back side of the first modular planter curb; forming at least one second connector point on the second back side of the second modular planter curb; providing connector hardware operable to interconnect the first modular planter curb and the second modular planter curb via the at least one first connector point and the at least one second connector point; and securing the connector hardware at the at least one first connector points and the at least one second connector point to interconnect the first modular planter curb and the second modular planter curb.

Other features and aspects of this invention will become more fully apparent from the following detailed description, the appended claims and the accompanying drawings.

### BRIEF DESCRIPTION OF THE DRAWINGS

Features of the invention can be more clearly understood from the following detailed description considered in conjunction with the following drawings, in which the same reference numerals denote the same elements throughout, and in which:

FIG. 1 shows a plan view of an exemplary embodiment of a multi-planter configuration of a modular planter system according to aspects of the invention.

FIG. 2 shows a side elevation view of a cross-section of a perimeter portion of a first exemplary embodiment of a planter according to aspects of the invention, wherein a simple tapered curb is depicted.

FIG. 3 shows a side elevation view of a cross-section of a perimeter portion of a second exemplary embodiment of a planter according to aspects of the invention, wherein a bench curb with an integrated bench top is depicted.

FIG. 4 shows a side elevation view of a cross-section of a perimeter portion of a third exemplary embodiment of a planter according to aspects of the invention, wherein a bench curb with an integrated bench top and an attached backrest is depicted.

FIG. 5 shows a side elevation view of a cross-section of a perimeter portion of a fourth exemplary embodiment of a planter according to aspects of the invention, wherein a bench curb with an integrated bench top and an attached daybed is depicted.

FIGS. 6A and 6B respectively show plan and elevation views of an exemplary embodiment of a full circle of an annular, simple, tapered curb according to aspects of the invention.

FIGS. 7A and 7B respectively show plan and elevation views of an exemplary embodiment of a partial circle of an annular, simple, tapered curb according to aspects of the invention.

FIGS. 8A and 8B respectively show plan and elevation views of an exemplary embodiment of a straight, simple, tapered curb according to aspects of the invention.

FIGS. 9A and 9B respectively show plan and elevation views of an exemplary embodiment of a straight, bench-to-simple transition curb according to aspects of the invention.

FIG. 10 shows plan views of exemplary embodiments of assorted-sized arc curbs depicted as partial circles of increasing angles of annular, simple, tapered curbs according to aspects of the invention.

FIG. 11 shows a plan view of an exemplary embodiment of a single planter configuration of a modular planter system according to aspects of the invention, the configuration including an assortment of curbs.

FIGS. 12A and 12B respectively show perspective views of another exemplary embodiment of a single planter configuration of a modular planter system according to aspects of the invention, wherein FIG. 12A depicts the planter as empty, and FIG. 12B depicts the planter as containing plants.

### DETAILED DESCRIPTION

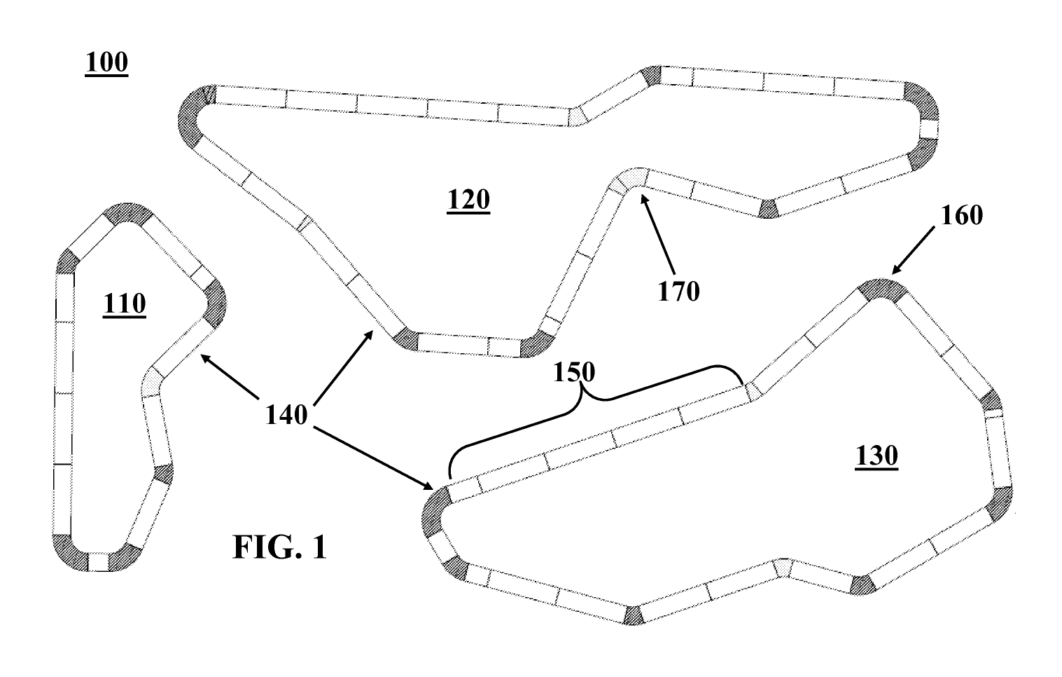

Referring to FIG. 1, FIG. 1 shows a plan view of an exemplary embodiment of a multi-planter configuration 100 of a modular planter system (MPS) according to aspects of the invention. Multi-planter configuration 100 includes three configurations that may serve as three planters 110, 120, 130. The modular planter system provides a simple, modular and flexible planter assembly concept for creating planted areas on roofs and structures.

An exemplary MPS may be comprised of a collection of different-shaped, pre-cast concrete modular curbs 140 that can be arranged and assembled into numerous configurations and planters shapes and area sizes. An exemplary configuration includes straight curb sections 150, convex curved curb sections 160, and/or concave curved curb sections 170 that can be arranged together to form the perimeter walls of one or more planters 110, 120, 130. The specific geometries and radii of the curbs and curb sections are organized in a way that fit closely together to form a variety of planter shapes and sizes. The close fit of the curbs affords a better seal and reduces unwanted erosion and drainage potentially occurring between the curbs. Although not depicted, planters 110, 120, and 130 likely would have electrical conduit, irrigation pipes, and drainage channels connecting the planters 110, 120, 130 with a source of electricity, a source of water, and a drain.

As used herein, a configuration refers to an assembly of a plurality of curbs. One or more curbs may form a section, and a section refers to the curb(s) forming a particular feature or sharing a trait. For example, a configuration may have a straight section, a curved section, a seating section, and/or a daybed section. A configuration typically forms a closed-loop perimeter that may function as a planter. A planter is an enclosure that is intended to contain soil and hopefully vegetation, and that often will include irrigation and drainage components. A planter may comprise an open-ended configuration in the event, for example, that open ends of the configuration abut against another barrier, such as a building wall. A configuration may form an open-ended arc or line that may or may not retain soil and vegetation. For example, an open-ended configuration may serve as a pedestrian barrier and durable seating arrangement without being a planter (a non-planter configuration), or it may serve as a retaining wall abutting a change in elevation (a retaining configuration). For instance, a non-planter configuration might allow ingress and egress into a closed-loop (or almost closed-loop) enclosure and afford seating both inside and outside the enclosure perimeter.

As a modular system, an MPS configuration can be deployed and assembled relatively easily. The modular nature of the system also enables the individual units to be re-used and reconfigured, extending the potential life cycle of an exemplary MPS configuration. With a wide assortment of specific geometries and types of curb units, the MPS enables a vast number of planter configurations to be created and formed.

Once fabricated offsite, an MPS configuration may be delivered and installed together or in pieces. After delivery of the MPS components, an installer assembles them in accordance with a simple map and key illustrating the individual pieces and their positions in the final geometry. Installation of any associated electrical, irrigation and drainage components may be done before, during or after assembly of an MPS configuration, depending on the design of the system. Exemplary MPS embodiments may be configured into a variety of rounded-edge, closed-loop geometries having continuous planter walls. The individual pieces then may be secured and/or locked in place at connection points on the back sides of the curbs. Any suitably durable hardware, such as nuts, bolts, screws and connector plates, may be used to secure and/or lock the curbs with each other or with other components. Unlocking the pieces allows them to be disassembled, re-configured and moved easily in order to provide a flexible, cost-effective solution to creating large and varied areas of planting.

An exemplary MPS configuration may contain soil of varying depths, measured from the base of any shims raising up an MPS curb to a high point of the soil. In a “low height” embodiment, an MPS configuration may be used as a continuous edge for a planted area having a soil depth of two to six inches. In a “standard height” embodiment, an MPS configuration may be used as a continuous edge for a planted area having a soil depth of six to thirty inches. In a “high height” embodiment, an MPS configuration may be used as a continuous edge for a planted area having a soil depth of greater than thirty inches. A standard MPS curb may have a concrete unit of about 16 inches to about 24 inches high, of about 10 inches to about 16 inches deep at its base, and of about 3 inches to about 20 inches deep at its top surface, with a curb length dependent on it position in an overall design.

The MPS overcomes several challenges of building a planted area on a roof, or any other structure. In particular, an MPS configuration is structurally self-supporting, avoiding the need to be attached to the roof, and therefore may be installed without penetrating any existing waterproofing membrane. As such, use of the MPS avoids the need for complicated waterproofing details and reduces costs, which is a huge advantage over conventional systems that require connecting to the structure through the membrane. In this context, self-supporting refers to more than just an unsupported curb standing upright in isolation; rather, an unsupported curb is self-supporting when it stands upright while resisting the outward force of soil pressing against the back side of the curb.

The MPS may provide numerous other features. For example, an MPS configuration may include integrated, self-supporting furniture to provide optional seating elements in order to reduce cost of additional furniture. The integrated seating is durable as well as immobile, reducing the risks of costs from potential wear, vandalism, and/or theft. The MPS also may accommodate irrigation pipes, drainage channels, and/or electrical conduit.

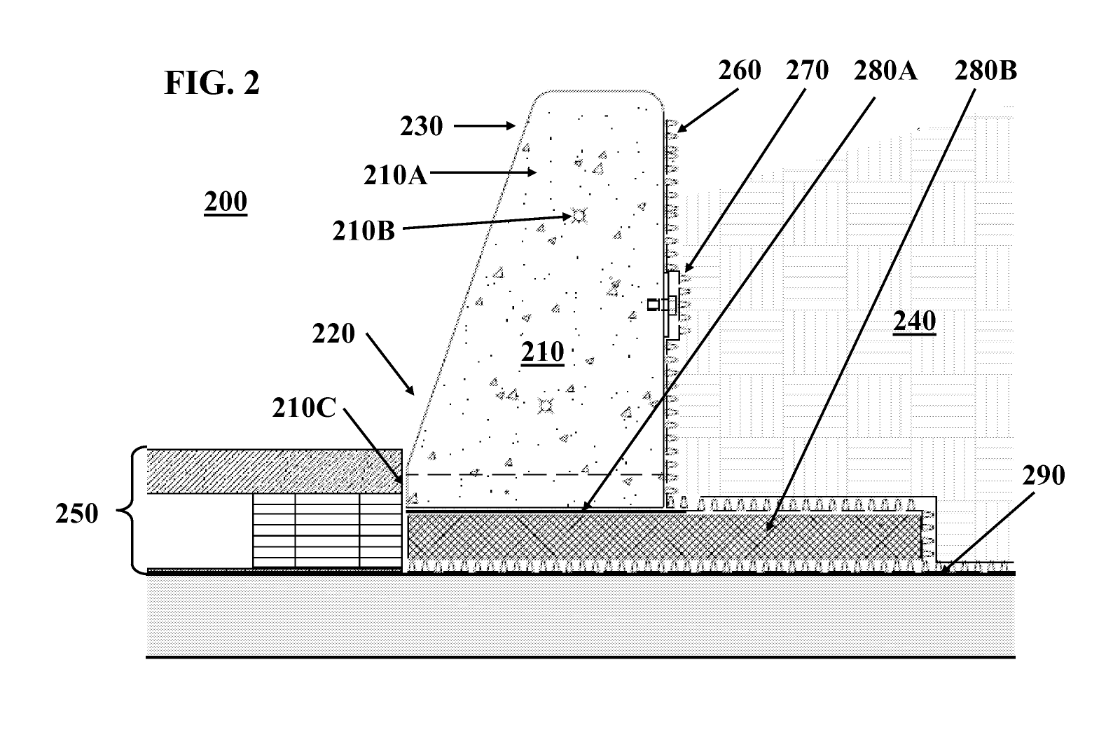

Referring to FIGS. 2 to 5, cross-sections of four exemplary embodiments of MPS curbs are shown in the context of roof-top planter configurations. FIG. 2 shows a side elevation view of a cross-section of a perimeter portion 200 of a first exemplary embodiment of a planter according to aspects of the invention, wherein a simple tapered curb 210 is depicted. As used herein, a simple curb refers to a curb top that does not include additional features like a bench, a backrest, a daybed, or other upgrade. Curb 210 is tapered on a front side from a lower portion 220 (having an exemplary depth of about 12 inches) towards an upper portion 230 (having an exemplary depth of about 4 inches and an exemplary height of about 20 inches). Tapering may reduce the overall weight of curb 210 relative to its footprint, as well as improve stability by lowering the center of gravity of curb 220. Curb 210 may comprise a concrete mixture 210A and possible steel reinforcement 210B.

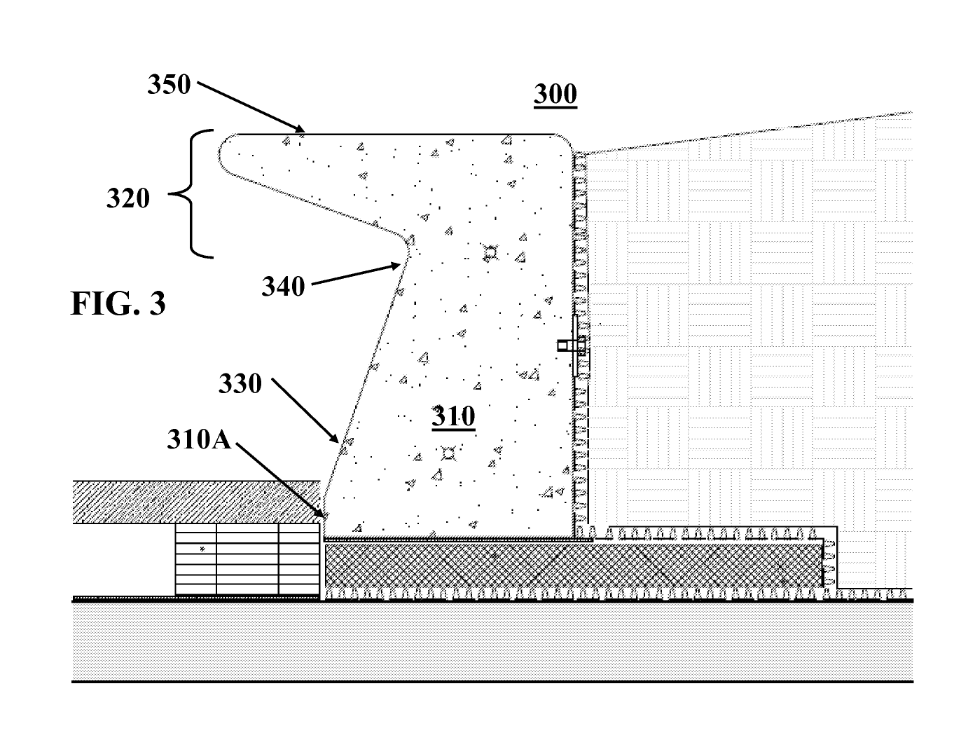

Planter perimeter portion 200 is shown having a planting medium 240 (e.g., soil, mulch, wood chips, etc.) on the right, curb 210 in the middle, and part of pedestrian platform 250 on the left. Curb 210 may have a cut-corner front toe 210C to provide a flat front surface flush against the pedestrian platform 250, and curb 210 is depicted as tapering at an angle of about 160 degrees relative to front toe 210C. Also depicted are a drainage mat 260 between curb 210 and soil 240; curb connector hardware 270 (e.g., metal plates, bolts, nuts, screws, etc.) to secure curb 210 to another curb at connector points on each curb; protection board 280A to shim curb 210 as needed; high-density styrene 280B (e.g., 60 PSI) to shim curb 210 as needed; and an existing roof waterproof membrane 290. Connector points might comprise drill holes, drill markings, embedded nuts, anchors, embedded bolts, etc., depending on the nature of connector hardware 270 chosen to interconnect the curbs. Analogous items are depicted in the planter perimeter portions shown FIGS. 3 to 5.

Similarly, FIG. 3 shows a side elevation view of a cross-section of a perimeter portion 300 of a second exemplary embodiment of a planter according to aspects of the invention, wherein a bench curb 310 with an integrated bench top 320 is depicted. Bench curb 310 begins with a wide lower portion 330 (having an exemplary depth of about 12 inches) and tapers on a front side upward to upper portion 340 (having an exemplary depth of about 8 inches at a height of about 14 inches), before bench top 320 extends over and beyond lower portion 330 to form a seating surface 350 (having an exemplary depth of about 16 inches at an exemplary height of about 20 inches). Curb 310 also may have a cut-corner front toe 310A to provide a flat front surface, and curb 310 is depicted as tapering at an angle of about 160 degrees relative to front toe 310A. In addition, bench curb 310 tapers along bench top 320 at an angle of about 20 degrees relative to the plane of seating surface 350.

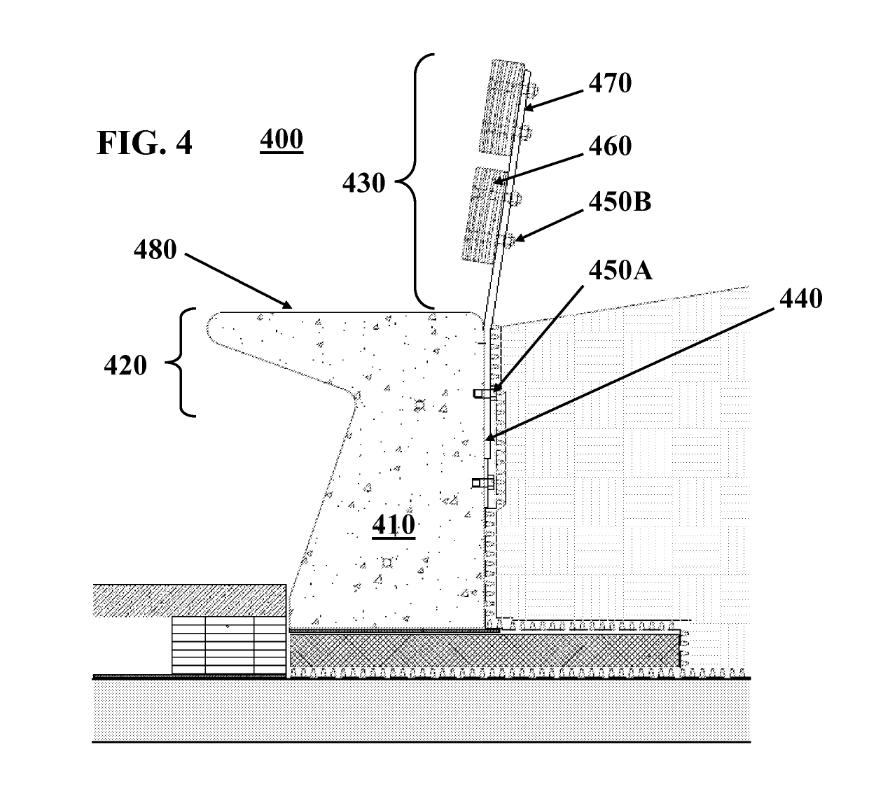

Likewise, FIG. 4 shows a side elevation view of a cross-section of a perimeter portion 400 of a third exemplary embodiment of a planter according to aspects of the invention, wherein a bench curb 410 with an integrated bench top 420 and an attached backrest 430 is depicted. Bench curb 410 may also be referred to as a backrest curb 410. Backrest 430 may be secured to curb 410 on a back side 440. Backrest 430 may include backrest connector hardware 450A (e.g., metal plates, bolts, nuts, screws, etc.) that secure backrest 430 to back side 440. Backrest 430 also may include backrest connector hardware 450B that secures backrest boards 460 to backrest support 470, which is secured by connector hardware 450B to back side 440. Backrest 430 may be inclined relative to a seating surface 480 at an angle of about 100 degrees and rise above seating surface 480 by about 16 inches, for example.

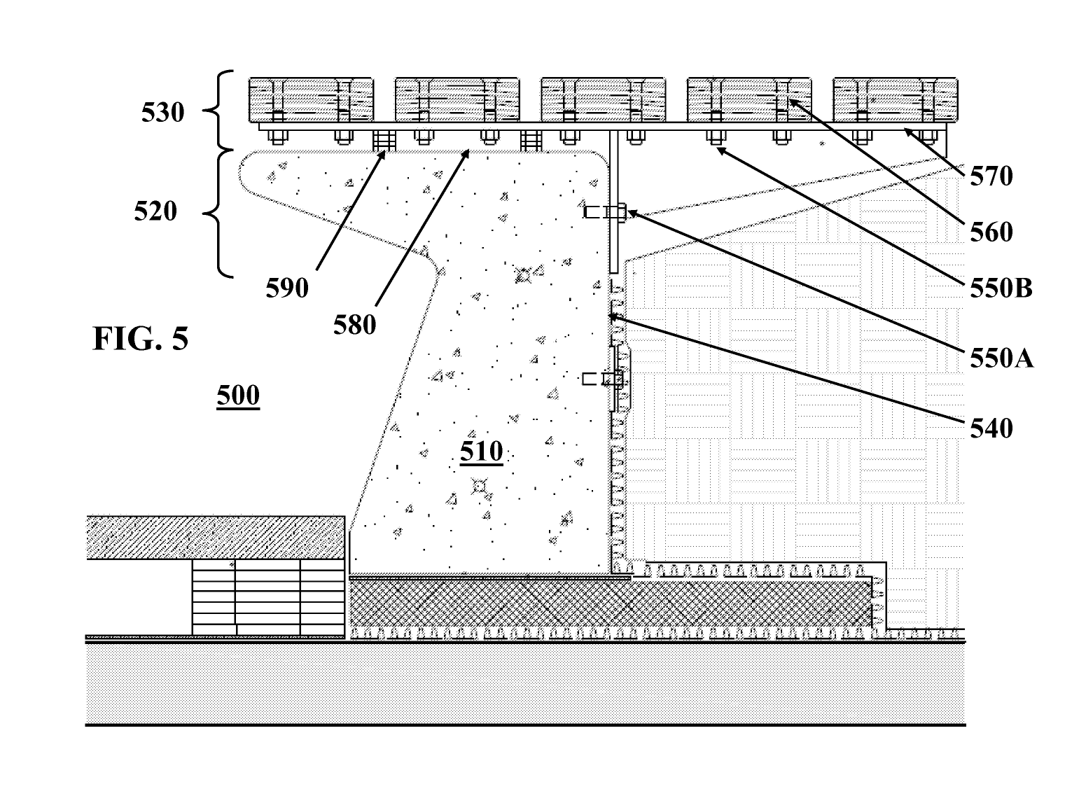

FIG. 5 shows a side elevation view of a cross-section of a perimeter portion 500 of a fourth exemplary embodiment of a planter according to aspects of the invention, wherein a bench curb 510 with an integrated bench top 520 and an attached daybed 530 is depicted. Bench curb 510 may also be referred to as a daybed curb 510. Daybed 530 may be secured to curb 510 on a back side 540. Daybed 530 may include daybed connector hardware 550A (e.g., metal plates, bolts, nuts, screws, etc.) that secure daybed 530 to back side 540. Daybed 530 also may include daybed connector hardware 550B that secures daybed boards 560 to daybed support 570, which is secured by connector hardware 550B to back side 540. Daybed 530 may be approximately parallel to a surface 580. Daybed bumper supports 590 may be used to support daybed 530 over bench top 520. Daybed bumper supports 590 may rest against, or be secured to, surface 580. Daybed 530 may be about 30 inches deep, for example, extending about 15 inches front and back of back side 540.

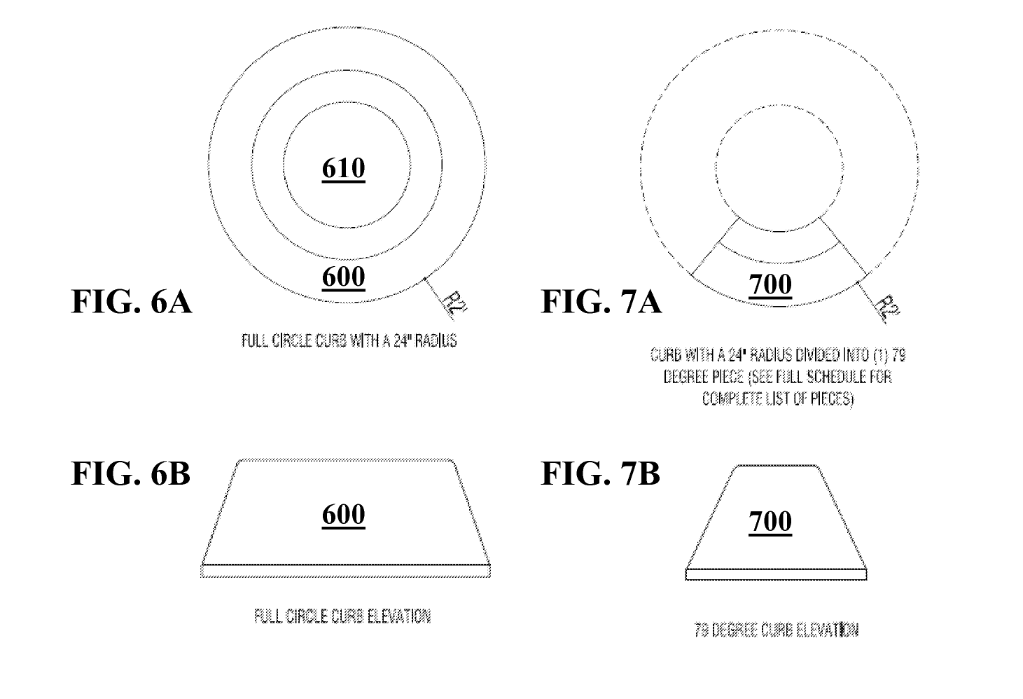

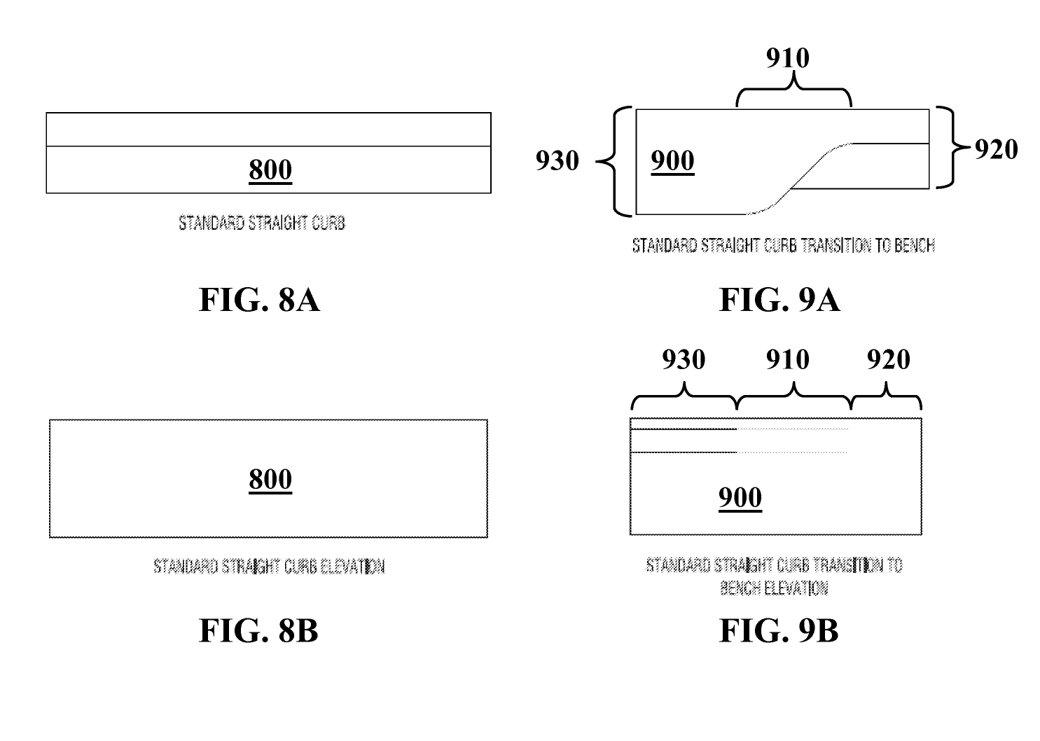

Referring to FIGS. 6A to 9B, four exemplary embodiments of MPS curbs are shown in plan and elevation views. These four curbs represent just a few of numerous shapes and features contemplated in the invention. For instance, in addition to the depicted straight, circular, and semi-circular curbs, curbs may rectangular, triangular, oblique, ovular, or a combination thereof. FIGS. 6A and 6B respectively show plan and elevation views of an exemplary embodiment of a full circle of an annular, simple, tapered curb 600 according to aspects of the invention. Annular curb 600 may serve as a single-curb planter unto itself, as it fully encloses a planting space 610. In contrast, FIGS. 7A and 7B respectively show plan and elevation views of an exemplary embodiment of a partial circle of an annular, simple, tapered curb 700 according to aspects of the invention. Annular arc curb 700 may be suitable for use as a rounded corner, for example, connecting two straight curbs, such as shown in FIGS. 8A to 9B.

FIGS. 8A and 8B respectively show plan and elevation views of an exemplary embodiment of a straight, simple, tapered curb 800 according to aspects of the invention. Straight curb 800 may represent an economical component to creating a large perimeter MPS configuration. Similarly, FIGS. 9A and 9B respectively show plan and elevation views of an exemplary embodiment of a straight, bench-to-simple transition curb 900 according to aspects of the invention. Transition curb 900 includes a transition 910 from a simple upper portion 920 to a bench top 930. Transition 910 may be smooth and gradual, as depicted, or more angular and abrupt. Although not depicted, a bench top may be formed on a concave or convex curved curb to create rounded seating surfaces.

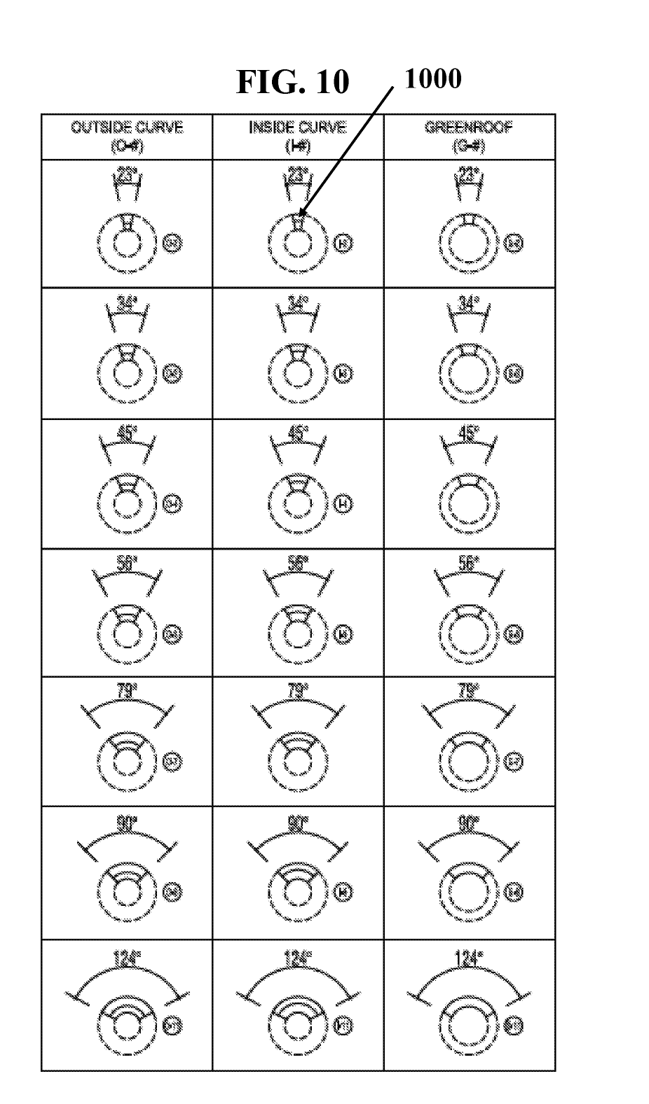

Annular arc curb 700 represents just one of numerous arc shapes that may be derived from annular curb 600. With respect to a given annular curb 600, an arc curb may be characterized by the number of degrees that the arc covers on a circle formed by the annular curb. FIG. 10 shows plan views of exemplary embodiments of assorted-sized arc curbs depicted as partial circles of increasing angles of annular, simple, tapered curbs according to aspects of the invention. For example, arc curb 1000 covers 23 degrees of the reference annular curb depicted in dashed lines.

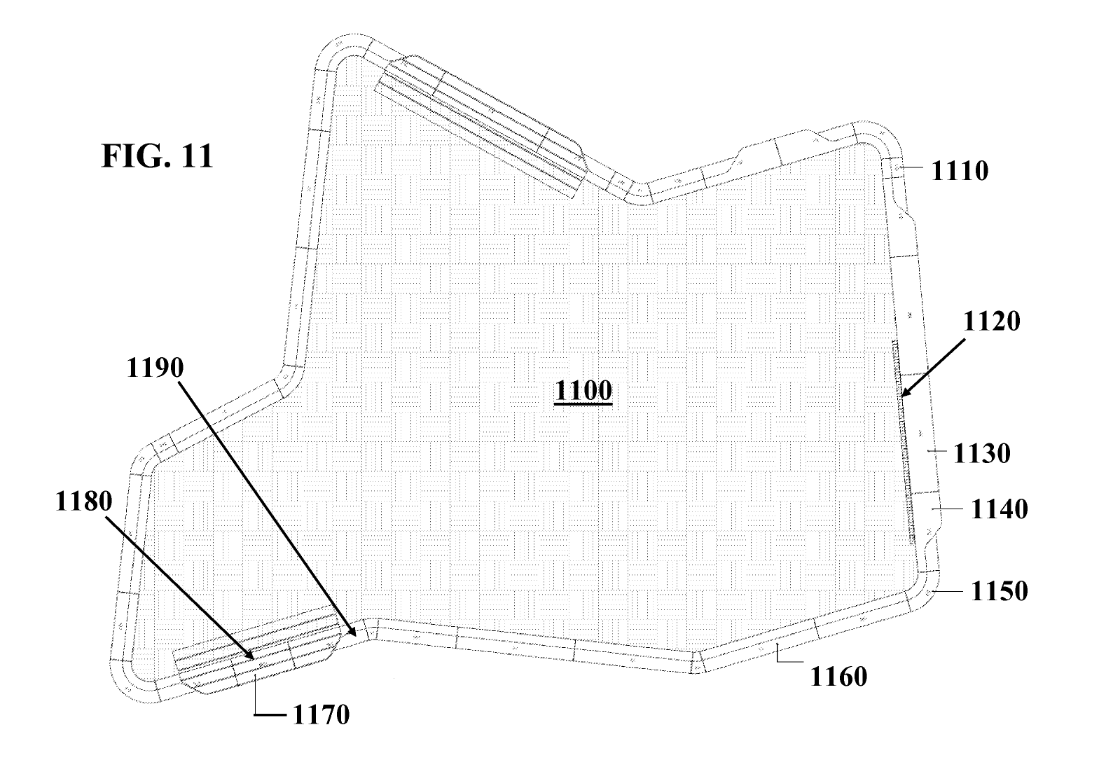

When assorted curbs are assembled in a configuration, the configuration may take almost any shape. FIG. 11 shows a plan view of an exemplary embodiment of a single planter configuration 1100 of a modular planter system according to aspects of the invention, the configuration including an assortment of curbs. As depicted, configuration 1100 includes, among others, a standard simple straight curb 1110 of variable length; a backrest 1120 supported in part by a bench curb 1130 of longer length and a transition curb 1140 of medium length; an outer convex curve curb 1150; a standard simple straight curb 1160 of longer length; and a daybed 1170 attached to a bench curb 1180 of variable length and two transition curbs 1190. The planter also is depicted as containing a planting medium, represented by alternating checkers.

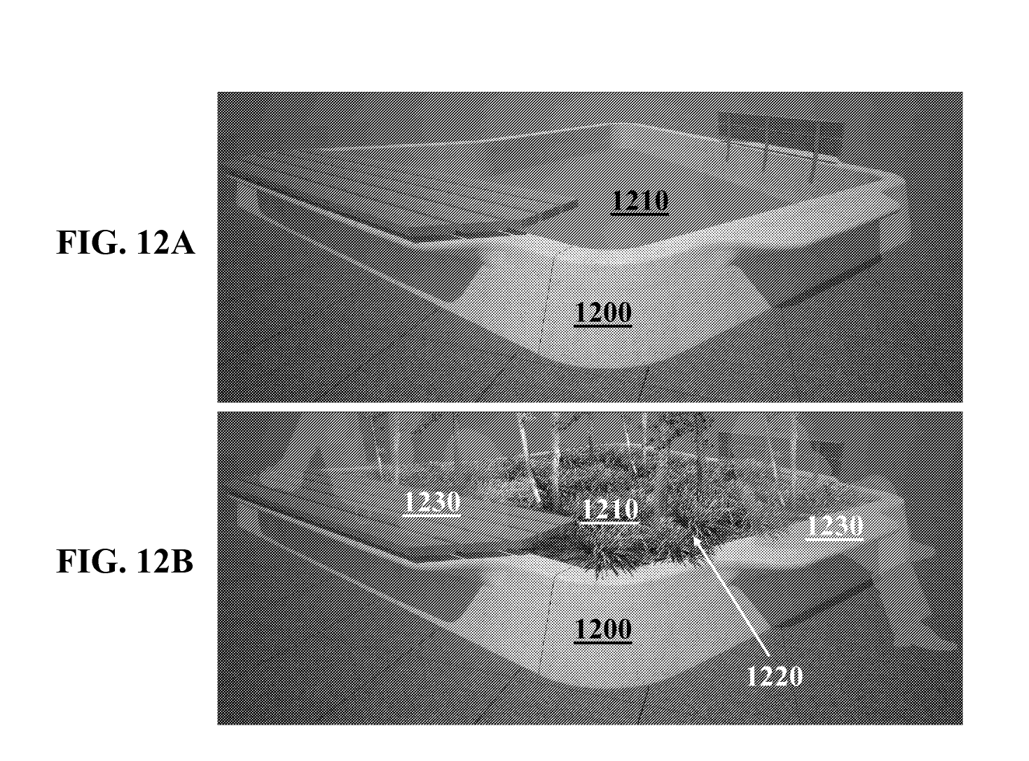

Visualization of the MPS may be aided with the help of computer renderings of an exemplary configuration. FIGS. 12A and 12B respectively show perspective views of another exemplary embodiment of a single planter configuration 1200 of a modular planter system according to aspects of the invention. FIG. 12A depicts the planter 1200 as having a planting space 1210 that is empty, while FIG. 12B depicts planting space 1210 as containing plants 1220. Pedestrians 1230 are portrayed relaxing on planter 1200 and next to the plants 1220.

Components of an MPS may be fabricated from standard concrete mixtures, including recycled concrete, and may be fabricated using a single custom mold to reduce material, labor, and costs, as well as waste. In this context, a single custom mold may refer, for example, to a collection of master molds of curbs of numerous shapes and sizes, and depending on the curbs needed for a desired configuration, each necessary master mold is used and reused to fabricate all necessary curbs. The master molds may then be reused for a subsequent project, and so on.

The MPS may be molded using precast concrete, not unlike a Jersey Barrier. A Jersey Barrier forms a solid concrete wedge having a symmetrical cross-section that is specifically designed to separate lanes of oncoming traffic, minimize vehicle damage in cases of incidental contact, and prevent vehicular crossovers that could lead to head-on collisions. A standard Jersey Barrier is at least 32 inches high (over 30% taller than an MPS curb), while its Canadian cousin, the Ontario Tall Wall stands 42 inches high (over 75% taller than an MPS curb). However, unlike the Jersey Barrier, which may be made of coarse, low-grade concrete, an MPS curb likely will need to have a smooth, finished surface made of finer concrete. For instance, the concrete unit of a curb may comprise precast concrete, cast stone, and/or precast stone. Architectural precast stone and cast stone are Portland cement-based architectural precast concrete products manufactured using high quality fine and coarse aggregate as primary constituents. Using a high percentage of fine aggregate creates a very smooth, consistent texture for the building elements being cast, resembling natural cut stone. As such, cast stone is a refined architectural concrete masonry material manufactured to simulate natural cut stone. In some cases, also uncharacteristic of Jersey Barriers, an MPS curb may be partially hollow or include lightweight fill to reduce unit weight.

Moreover, Jersey Barriers are symmetrical in cross-section, front to back, because they serve the same purpose on each side, namely to restrain traffic moving along the length of the barrier. Inasmuch as the front and back of an MPS curb serve different purposes (the front faces pedestrians, while the back holds back soil), an MPS curb typically will be asymmetrical in cross-section and have connection points on the back that are not present on the front. An MPS curb may have a front side that tapers from a wider lower portion to a narrower upper portion, with a back side that is substantially upright, having an angle relative to a curb base of between about 80 degrees (for a slight incline) and about 90 degrees (for no incline).

An exemplary MPS configuration may differ from a chain of interconnected Jersey Barriers in several ways. For instance, a chain of Jersey Barriers commonly comprises barriers of only one shape and size that may be made from an individual mold. In contrast, the MPS is designed to create diverse geometrically-shaped planters that account for proper drainage and soil retention. An exemplary MPS configuration may be relatively lightweight in order to be installed on top of structures with load bearing limits, such as roofs and structural slabs. Conversely, a chain of Jersey Barriers on a roof likely would damage the building. Nonetheless, in the event that an MPS is intended for use as a planter system with vehicular barrier features, the MPS curbs may be made solid, to add weight and stability to resist a vehicular impact.

The foregoing description discloses exemplary embodiments of the invention, which has been described with the reference to the exemplary embodiments. The specification and drawings, accordingly, should be regarded in an illustrative rather than restrictive sense. Various modifications and changes may be made to the embodiments without departing from the broadest spirit and scope of the invention. Modifications of the above disclosed apparatus and methods that fall within the scope of the invention will be readily apparent to those of ordinary skill in the art. Accordingly, additional embodiments may fall within the spirit and scope of the invention, as defined by the following claims.

1. A device comprising a modular planter curb, wherein the modular planter curb comprises a concrete unit having a back side that is substantially upright, having a front side that tapers from a wider lower portion to a narrower upper portion, and having a height not exceeding 24 inches; and wherein the concrete unit comprises precast concrete, cast stone, and/or precast stone.

2. The device of claim 1, wherein the modular planter curb further comprises a bench curb, and the concrete unit further comprises a bench top above the narrower upper portion.

3. The device of claim 2, wherein the modular planter curb further comprises a backrest secured to the concrete unit.

4. The device of claim 2, wherein the modular planter curb further comprises a daybed secured to the concrete unit.

5. The device of claim 1, wherein the modular planter curb further comprises a transition curb, and the concrete unit further comprises a bench top, a simple upper portion, and a transition from the bench top to the simple upper portion.

6. The device of claim 1, wherein the modular planter curb further comprises a straight curb.

7. The device of claim 1, wherein the modular planter curb further comprises a curved curb.

8. The device of claim 7, wherein the modular planter curb further comprises an annular arc curb.

9. The device of claim 7, wherein the modular planter curb further comprises a full annular curb.

10. A system comprising a plurality of modular planter curbs, wherein each modular planter curb comprises a concrete unit having a back side that is substantially upright, having a front side that tapers from a wider lower portion to a narrower upper portion, and having a height not exceeding 24 inches; wherein the concrete unit comprises precast concrete, cast stone, and/or precast stone; wherein each modular planter curb further comprises connector points; and wherein the system further comprises connector hardware to interconnect the plurality of modular planter curbs at the connector points.

11. The system of claim 10, wherein the connector hardware interconnects the plurality of modular planter curbs at the connector points.

12. The system of claim 11, wherein the plurality of modular planter curbs comprises differing modular planter curbs selected from the group comprising a bench curb, a backrest curb, a daybed curb, a transition curb, a straight curb, a curved curb, an annular arc curb, and a full annular curb.

13. The system of claim 12, wherein the bench curb comprises a concrete unit further comprises a bench top above the narrower upper portion.

14. The system of claim 12, wherein the backrest curb comprises a backrest secured to the concrete unit, and wherein the daybed curb comprises a daybed secured to the concrete unit.

15. A method for forming a configuration of a modular planter system, the method comprising: forming a first modular planter curb, wherein the first modular planter curb comprises a first concrete unit having a first back side that is substantially upright, having a first front side that tapers from a first wider lower portion to a first narrower upper portion, and having a first height not exceeding 24 inches; and wherein the first concrete unit comprises precast concrete, cast stone, and/or precast stone.

16. The method of claim 15, further comprising: forming a second modular planter curb, wherein the second modular planter curb comprises a second concrete unit having a second back side that is substantially upright, having a second front side that tapers from a second wider lower portion to a second narrower upper portion, and having a second height not exceeding 24 inches; and wherein the second concrete unit comprises precast concrete, cast stone, and/or precast stone.

17. The method of claim 16, wherein the first modular planter curb and the second modular planter curb differ and are selected from the group comprising a bench curb, a backrest curb, a daybed curb, a transition curb, a straight curb, a curved curb, an annular arc curb, and a full annular curb.

18. The method of claim 16, further comprising: forming at least one first connector point on the first back side of the first modular planter curb; and forming at least one second connector point on the second back side of the second modular planter curb.

19. The method of claim 18, further comprising: providing connector hardware operable to interconnect the first modular planter curb and the second modular planter curb via the at least one first connector point and the at least one second connector point.

20. The method of claim 19, further comprising: securing the connector hardware at the at least one first connector points and the at least one second connector point to interconnect the first modular planter curb and the second modular planter curb.
